(19) United States
(12) Patent Application Publication
(10) Pub. No.: US 2015/0119037 A1
(43) Pub. Date: Apr. 30, 2015

(54) CELL RESELECTION WITH MULTIPLE SEARCH LISTS

(71) Applicant: QUALCOMM Incorporated, San Diego, CA (US)

(72) Inventors: Thawatt GOPAL, San Diego, CA (US); Scott Allan HOOVER, San Diego, CA (US); Tom CHIN, San Diego, CA (US)

(73) Assignee: QUALCOMM Incorporated, San Diego, CA (US)

(21) Appl. No.: 14/068,875

(22) Filed: Oct. 31, 2013

(51) Int. Cl. H04W 36/00; H04W 88/06

(52) U.S. Cl. CPC H04W 36/0066; H04W 88/06
USPC 455/436; 455/552.1

(57) ABSTRACT

A method of wireless communication includes receiving a set of frequency layers for intra radio access technology (RAT) inter-frequency cell reselection and/or a set of frequency layers for inter RAT frequency cell reselection. The method also includes storing two or more of the frequency layers in an active search list and storing one or more remaining frequency layers in a dormant search list. The method further includes searching for each frequency layer in the active search list. The method still further includes dynamically updating a measurement list, the active search list, and the dormant search list.

### BACKGROUND

1. Field

Aspects of the present disclosure relate generally to wireless communication systems, and more particularly, to improving cell reselection using active and dormant search lists when a network broadcasts an increased number of target inter-RAT (IRAT) and/or inter-frequency reselection candidates.

2. Background

Wireless communication networks are widely deployed to provide various communication services such as telephony, video, data, messaging, broadcasts, and so on. Such networks, which are usually multiple access networks, support communications for multiple users by sharing the available network resources. One example of such a network is the Universal Terrestrial Radio Access Network (UTRAN). The UTRAN is the radio access network (RAN) defined as a part of the Universal Mobile Telecommunications System (UMTS), a third generation (3G) mobile phone technology supported by the 3rd Generation Partnership Project (3GPP). The UMTS, which is the successor to Global System for Mobile Communications (GSM) technologies, currently supports various air interface standards, such as Wideband-Code Division Multiple Access (W-CDMA), Time Division-Code Division Multiple Access (TD-CDMA), and Time Division-Synchronous Code Division Multiple Access (TD-SCDMA). For example, China is pursuing TD-SCDMA as the underlying air interface in the UTRAN architecture with its existing GSM infrastructure as the core network. The UMTS also supports enhanced 3G data communications protocols, such as High Speed Packet Access (HSPA), which provides higher data transfer speeds and capacity to associated UMTS networks. HSPA is a collection of two mobile telephony protocols, High Speed Downlink Packet Access (HSDPA) and High Speed Uplink Packet Access (HSUPA), which extends and improves the performance of existing wideband protocols.

As the demand for mobile broadband access continues to increase, research and development continue to advance the UMTS technologies not only to meet the growing demand for mobile broadband access, but to advance and enhance the user experience with mobile communications.

### SUMMARY

In one aspect of the present disclosure, a method of wireless communication is presented. The method includes receiving a set of frequency layers for intra RAT inter-frequency cell reselection and/or a set of frequency layers for inter RAT frequency cell reselection. The method also includes storing two or more of the frequency layers in an active search list and storing one or more remaining frequency layer in a dormant search list. The method further includes searching for each frequency layer in the active search list. The method still further includes storing a selected frequency layer in the dormant search list when a search does not detect the first selected frequency layer. The method also includes storing the selected frequency layer in a measurement list when the search detects the first selected frequency layer. The method also includes dynamically updating the measurement list, the active search list, and the dormant search list.

Another aspect of the present disclosure is directed to an apparatus including means for receiving a set of frequency layers for intra RAT inter-frequency cell reselection and a set of frequency layers for inter RAT frequency cell reselection. The apparatus also includes means for storing two or more of the frequency layers in an active search list and means for storing one or more remaining frequency layer in a dormant search list. The apparatus further includes means for searching for each frequency layer in the active search list. The apparatus still further includes means for storing a selected frequency layer in the dormant search list when a search does not detect the first selected frequency layer. The apparatus also includes means for storing the selected frequency layer in a measurement list when the search detects the first selected frequency layer. The apparatus also includes means for dynamically updating the measurement list, the active search list, and the dormant search list.

In another aspect, a computer program product for wireless communications in a wireless network having a non-transitory computer-readable medium is disclosed. The computer readable medium has non-transitory program code recorded thereon which, when executed by the processor(s), causes the processor(s) to perform operations of receiving a set of frequency layers for intra RAT inter-frequency cell reselection and a set of frequency layers for inter RAT frequency cell reselection. The program code also causes the processor(s) to store two or more of the frequency layers in an active search list and to store one or more remaining frequency layers in a dormant search list. The program code further causes the processor(s) to search for each frequency layer in the active search list. The program code still further causes the processor(s) to store a selected frequency layer in the dormant search list when a search does not detect the first selected frequency layer. The program code also causes the processor(s) to store the selected frequency layer in a measurement list when the search detects the first selected frequency layer. The program code also causes the processor(s) to dynamically update the measurement list, the active search list, and the dormant search list.

Another aspect discloses wireless communication having a memory and at least one processor coupled to the memory. The processor(s) is configured to receive a set of frequency layers for intra RAT inter-frequency cell reselection and a set of frequency layers for inter RAT frequency cell reselection. The processor(s) is also configured to store two or more of the frequency layers in an active search list and to store one or more remaining frequency layer in a dormant search list. The processor(s) is further configured to search for each frequency layer in the active search list. The processor(s) is still further configured to store a selected frequency layer in the dormant search list when a search does not detect the first selected frequency layer. The processor(s) is also configured to store the selected frequency layer in a measurement list when the search detects the first selected frequency layer. The processor(s) is also configured to dynamically update the measurement list, the active search list, and the dormant search list.

This has outlined, rather broadly, the features and technical advantages of the present disclosure in order that the detailed description that follows may be better understood. Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

FIG. 1 is a block diagram conceptually illustrating an example of a telecommunications system.

FIG. 2 is a block diagram conceptually illustrating an example of a frame structure in a telecommunications system.

FIG. 3 is a block diagram conceptually illustrating an example of a node B in communication with a UE in a telecommunications system.

FIG. 4 illustrates network coverage areas according to aspects of the present disclosure.

FIG. 5 is a block diagram illustrating a method for improved cell reselection with multiple search lists according to one aspect of the present disclosure.

FIG. 6 is a diagram illustrating an example of a hardware implementation for an apparatus employing a processing system according to one aspect of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

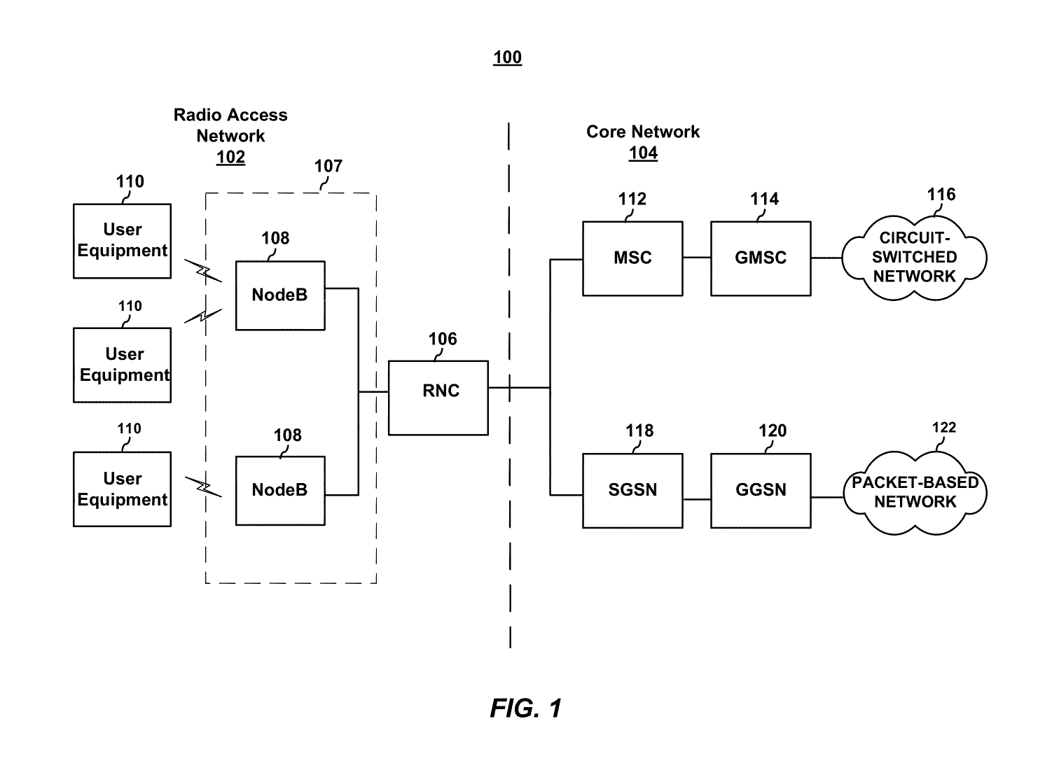

Turning now to FIG. 1, a block diagram is shown illustrating an example of a telecommunications system 100. The various concepts presented throughout this disclosure may be implemented across a broad variety of telecommunication systems, network architectures, and communication standards. By way of example and without limitation, the aspects of the present disclosure illustrated in FIG. 1 are presented with reference to a UMTS system employing a TD-SCDMA standard. In this example, the UMTS system includes a (radio access network) RAN 102 (e.g., UTRAN) that provides various wireless services including telephony, video, data, messaging, broadcasts, and/or other services. The RAN 102 may be divided into a number of Radio Network Subsystems (RNSs) such as an RNS 107, each controlled by a Radio Network Controller (RNC) such as an RNC 106. For clarity, only the RNC 106 and the RNS 107 are shown; however, the RAN 102 may include any number of RNCs and RNSs in addition to the RNC 106 and RNS 107. The RNC 106 is an apparatus responsible for, among other things, assigning, reconfiguring and releasing radio resources within the RNS 107. The RNC 106 may be interconnected to other RNCs (not shown) in the RAN 102 through various types of interfaces such as a direct physical connection, a virtual network, or the like, using any suitable transport network.

The geographic region covered by the RNS 107 may be divided into a number of cells, with a radio transceiver apparatus serving each cell. A radio transceiver apparatus is commonly referred to as a node B in UMTS applications, but may also be referred to by those skilled in the art as a base station (BS), a base transceiver station (BTS), a radio base station, a radio transceiver, a transceiver function, a basic service set (BSS), an extended service set (ESS), an access point (AP), or some other suitable terminology. For clarity, two node Bs 108 are shown; however, the RNS 107 may include any number of wireless node Bs. The node Bs 108 provide wireless access points to a core network 104 for any number of mobile apparatuses. Examples of a mobile apparatus include a cellular phone, a smart phone, a session initiation protocol (SIP) phone, a laptop, a notebook, a netbook, a smartbook, a personal digital assistant (PDA), a satellite radio, a global positioning system (GPS) device, a multimedia device, a video device, a digital audio player (e.g., MP3 player), a camera, a game console, or any other similar functioning device. The mobile apparatus is commonly referred to as user equipment (UE) in UMTS applications, but may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. For illustrative purposes, three UEs 110 are shown in communication with the node Bs 108. The downlink (DL), also called the forward link, refers to the communication link from a node B to a UE, and the uplink (UL), also called the reverse link, refers to the communication link from a UE to a node B.

The core network 104, as shown, includes a GSM core network. However, as those skilled in the art will recognize, the various concepts presented throughout this disclosure may be implemented in a RAN, or other suitable access network, to provide UEs with access to types of core networks other than GSM networks.

In this example, the core network 104 supports circuit-switched services with a mobile switching center (MSC) 112 and a gateway MSC (GMSC) 114. One or more RNCs, such as the RNC 106, may be connected to the MSC 112. The MSC 112 is an apparatus that controls call setup, call routing, and UE mobility functions. The MSC 112 also includes a visitor location register (VLR) (not shown) that contains subscriber-related information for the duration that a UE is in the coverage area of the MSC 112. The GMSC 114 provides a gateway through the MSC 112 for the UE to access a circuit-switched network 116. The GMSC 114 includes a home location register (HLR) (not shown) containing subscriber data, such as the data reflecting the details of the services to which a particular user has subscribed. The HLR is also associated with an authentication center (AuC) that contains subscriber-specific authentication data. When a call is received for a particular UE, the GMSC 114 queries the HLR to determine the UE's location and forwards the call to the particular MSC serving that location.

The core network 104 also supports packet-data services with a serving GPRS support node (SGSN) 118 and a gateway GPRS support node (GGSN) 120. GPRS, which stands for General Packet Radio Service, is designed to provide packet-data services at speeds higher than those available with standard GSM circuit-switched data services. The GGSN 120 provides a connection for the RAN 102 to a packet-based network 122. The packet-based network 122 may be the Internet, a private data network, or some other suitable packet-based network. The primary function of the GGSN 120 is to provide the UEs 110 with packet-based network connectivity. Data packets are transferred between the GGSN 120 and the UEs 110 through the SGSN 118, which performs primarily the same functions in the packet-based domain as the MSC 112 performs in the circuit-switched domain.

The UMTS air interface is a spread spectrum Direct-Sequence Code Division Multiple Access (DS-CDMA) system. The spread spectrum DS-CDMA spreads user data over a much wider bandwidth through multiplication by a sequence of pseudorandom bits called chips. The TD-SCDMA standard is based on such direct sequence spread spectrum technology and additionally calls for a time division duplexing (TDD), rather than a frequency division duplexing (FDD) as used in many FDD mode UMTS/W-CDMA systems. TDD uses the same carrier frequency for both the uplink (UL) and downlink (DL) between a node B 108 and a UE 110, but divides uplink and downlink transmissions into different time slots in the carrier.

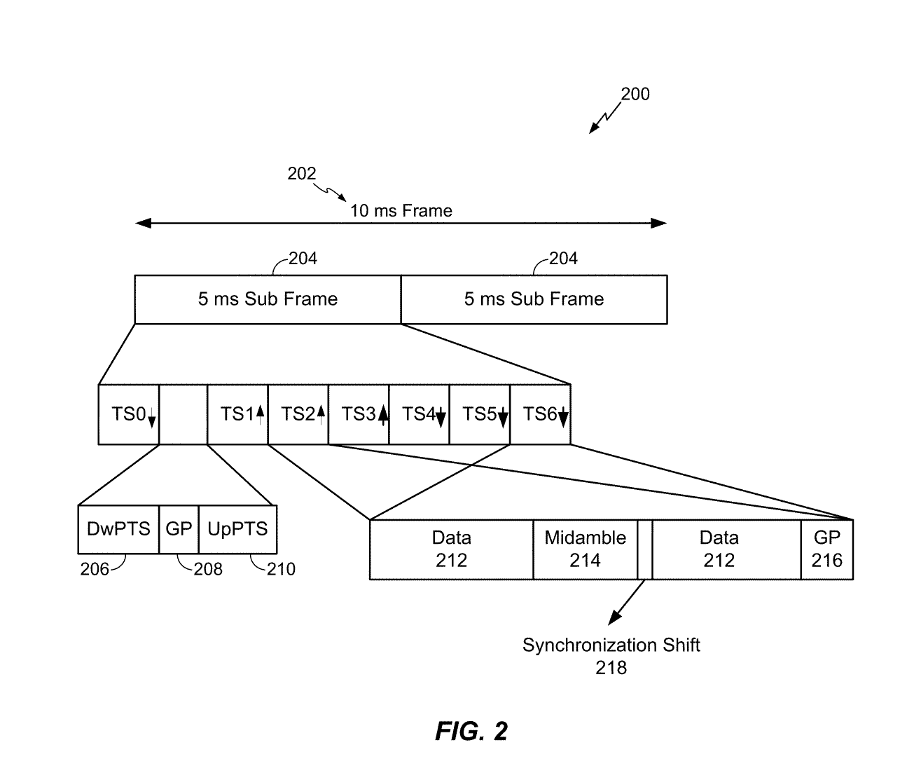

FIG. 2 shows a frame structure 200 for a TD-SCDMA carrier. The TD-SCDMA carrier, as illustrated, has a frame 202 that is 10 ms in length. The chip rate in TD-SCDMA is 1.28 Mcps. The frame 202 has two 5 ms subframes 204, and each of the subframes 204 includes seven time slots, TS0 through TS6. The first time slot, TS0, is usually allocated for downlink communication, while the second time slot, TS1, is usually allocated for uplink communication. The remaining time slots, TS2 through TS6, may be used for either uplink or downlink, which allows for greater flexibility during times of higher data transmission times in either the uplink or downlink directions. A downlink pilot time slot (DwPTS) 206, a guard period (GP) 208, and an uplink pilot time slot (UpPTS) 210 (also known as the uplink pilot channel (UpPCH)) are located between TS0 and TS1. Each time slot, TS0-TS6, may allow data transmission multiplexed on a maximum of 16 code channels. Data transmission on a code channel includes two data portions 212 (each with a length of 352 chips) separated by a midamble 214 (with a length of 144 chips) and followed by a guard period (GP) 216 (with a length of 16 chips). The midamble 214 may be used for features, such as channel estimation, while the guard period 216 may be used to avoid inter-burst interference. Also transmitted in the data portion is some Layer 1 control information, including Synchronization Shift (SS) bits 218. SS bits 218 only appear in the second part of the data portion. The SS bits 218 immediately following the midamble can indicate three cases: decrease shift, increase shift, or do nothing in the upload transmit timing. The positions of the SS bits 218 are not generally used during uplink communications.

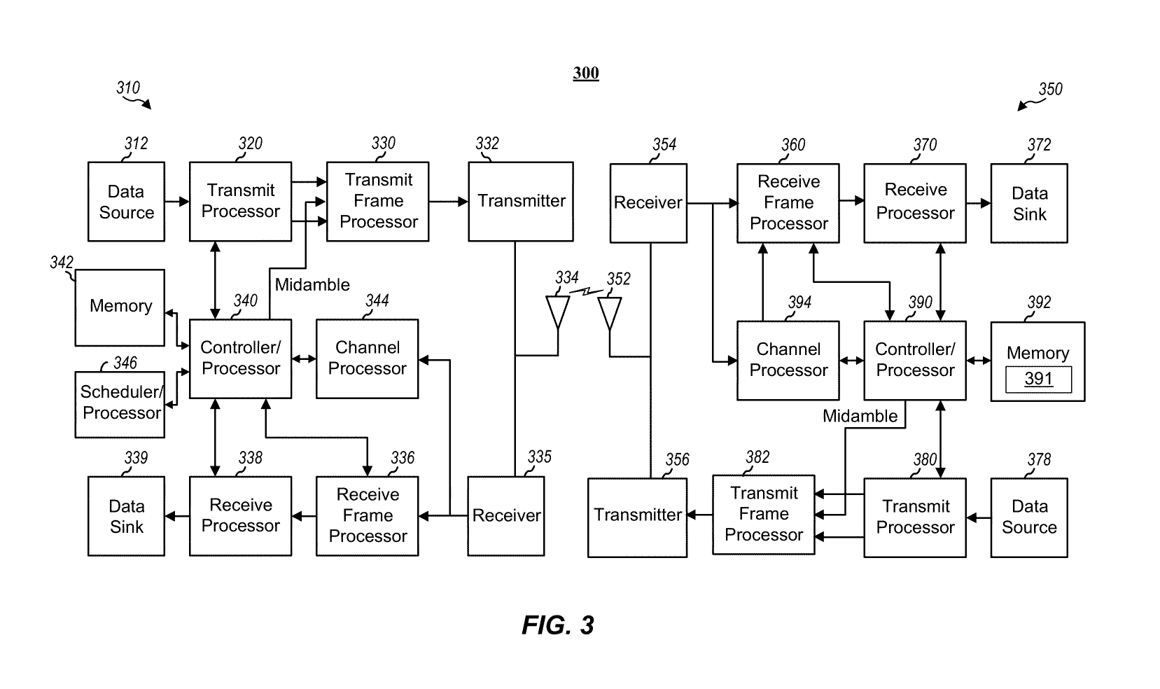

FIG. 3 is a block diagram of a node B 310 in communication with a UE 350 in a RAN 300, where the RAN 300 may be the RAN 102 in FIG. 1, the node B 310 may be the node B 108 in FIG. 1, and the UE 350 may be the UE 110 in FIG. 1. In the downlink communication, a transmit processor 320 may receive data from a data source 312 and control signals from a controller/processor 340. The transmit processor 320 provides various signal processing functions for the data and control signals, as well as reference signals (e.g., pilot signals). For example, the transmit processor 320 may provide cyclic redundancy check (CRC) codes for error detection, coding and interleaving to facilitate forward error correction (FEC), mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM), and the like), spreading with orthogonal variable spreading factors (OVSF), and multiplying with scrambling codes to produce a series of symbols. Channel estimates from a channel processor 344 may be used by a controller/processor 340 to determine the coding, modulation, spreading, and/or scrambling schemes for the transmit processor 320. These channel estimates may be derived from a reference signal transmitted by the UE 350 or from feedback contained in the midamble 214 (FIG. 2) from the UE 350. The symbols generated by the transmit processor 320 are provided to a transmit frame processor 330 to create a frame structure. The transmit frame processor 330 creates this frame structure by multiplexing the symbols with a midamble 214 (FIG. 2) from the controller/processor 340, resulting in a series of frames. The frames are then provided to a transmitter 332, which provides various signal conditioning functions including amplifying, filtering, and modulating the frames onto a carrier for downlink transmission over the wireless medium through smart antennas 334. The smart antennas 334 may be implemented with beam steering bidirectional adaptive antenna arrays or other similar beam technologies.

At the UE 350, a receiver 354 receives the downlink transmission through an antenna 352 and processes the transmission to recover the information modulated onto the carrier. The information recovered by the receiver 354 is provided to a receive frame processor 360, which parses each frame, and provides the midamble 214 (FIG. 2) to a channel processor 394 and the data, control, and reference signals to a receive processor 370. The receive processor 370 then performs the inverse of the processing performed by the transmit processor 320 in the node B 310. More specifically, the receive processor 370 descrambles and despreads the symbols, and then determines the most likely signal constellation points transmitted by the node B 310 based on the modulation scheme. These soft decisions may be based on channel estimates computed by the channel processor 394. The soft decisions are then decoded and deinterleaved to recover the data, control, and reference signals. The CRC codes are then checked to determine whether the frames were successfully decoded. The data carried by the successfully decoded frames will then be provided to a data sink 372, which represents applications running in the UE 350 and/or various user interfaces (e.g., display). Control signals carried by successfully decoded frames will be provided to a controller/processor 390. When frames are unsuccessfully decoded by the receiver processor 370, the controller/processor 390 may also use an acknowledgement (ACK) and/or negative acknowledgement (NACK) protocol to support retransmission requests for those frames.

In the uplink, data from a data source 378 and control signals from the controller/processor 390 are provided to a transmit processor 380. The data source 378 may represent applications running in the UE 350 and various user interfaces (e.g., keyboard). Similar to the functionality described in connection with the downlink transmission by the node B 310, the transmit processor 380 provides various signal processing functions including CRC codes, coding and interleaving to facilitate FEC, mapping to signal constellations, spreading with OVSFs, and scrambling to produce a series of symbols. Channel estimates, derived by the channel processor 394 from a reference signal transmitted by the node B 310 or from feedback contained in the midamble transmitted by the node B 310, may be used to select the appropriate coding, modulation, spreading, and/or scrambling schemes. The symbols produced by the transmit processor 380 will be provided to a transmit frame processor 382 to create a frame structure. The transmit frame processor 382 creates this frame structure by multiplexing the symbols with a midamble 214 (FIG. 2) from the controller/processor 390, resulting in a series of frames. The frames are then provided to a transmitter 356, which provides various signal conditioning functions including amplification, filtering, and modulating the frames onto a carrier for uplink transmission over the wireless medium through the antenna 352.

The uplink transmission is processed at the node B 310 in a manner similar to that described in connection with the receiver function at the UE 350. A receiver 335 receives the uplink transmission through the antenna 334 and processes the transmission to recover the information modulated onto the carrier. The information recovered by the receiver 335 is provided to a receive frame processor 336, which parses each frame, and provides the midamble 214 (FIG. 2) to the channel processor 344 and the data, control, and reference signals to a receive processor 338. The receive processor 338 performs the inverse of the processing performed by the transmit processor 380 in the UE 350. The data and control signals carried by the successfully decoded frames may then be provided to a data sink 339 and the controller/processor, respectively. If some of the frames were unsuccessfully decoded by the receive processor, the controller/processor 340 may also use an acknowledgement (ACK) and/or negative acknowledgement (NACK) protocol to support retransmission requests for those frames.

The controller/processors 340 and 390 may be used to direct the operation at the node B 310 and the UE 350, respectively. For example, the controller/processors 340 and 390 may provide various functions including timing, peripheral interfaces, voltage regulation, power management, and other control functions. The computer-readable media of memories 342 and 392 may store data and software for the node B 310 and the UE 350, respectively. For example, the memory 392 of the UE 350 may store a search list module 391 which, when executed by the controller/processor 390, configures the UE 350 to use an active search list, a dormant search list, and a measurement list for cell reselection. A scheduler/processor 346 at the node B 310 may allocate resources to the UEs and schedule downlink and/or uplink transmissions for the UEs.

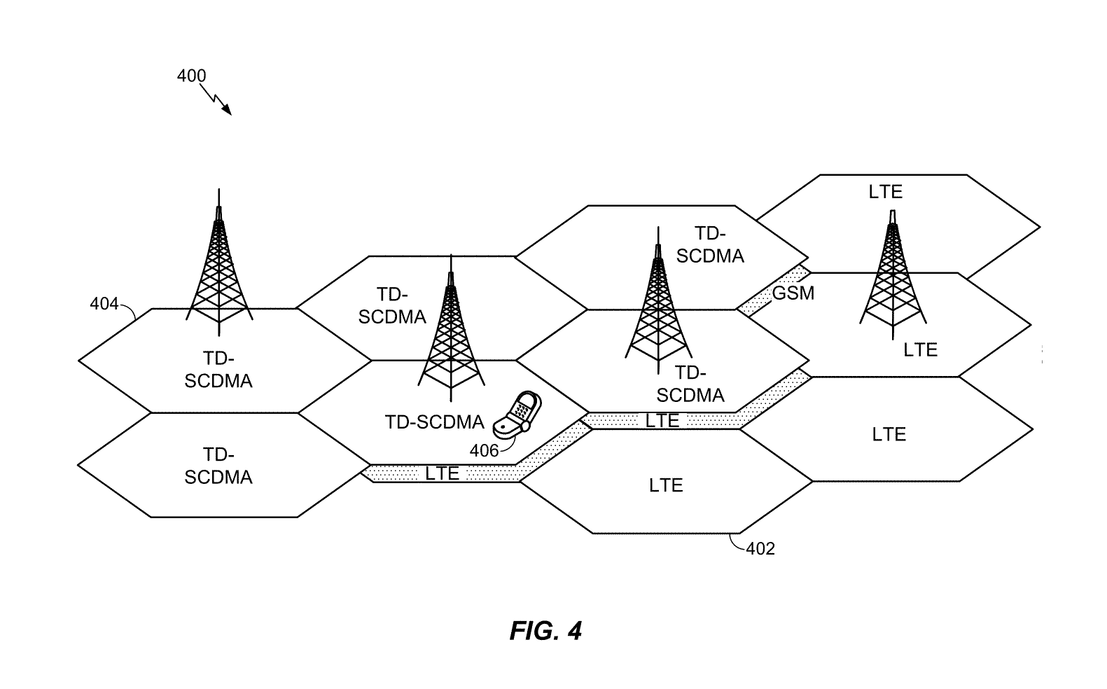

FIG. 4 illustrates coverage of a newly deployed network, such as an LTE network and also coverage of a more established network, such as a TD-SCDMA network. A geographical area 400 may include LTE cells 402 and TD-SCDMA cells 404. A user equipment (UE) 406 may move from one cell, such as a TD-SCDMA cell 404, to another cell, such as an LTE cell 402. The movement of the UE 406 may specify a handover or a cell reselection.

The handover or cell reselection may be performed when the UE moves from a coverage area of a TD-SCDMA cell to the coverage area of an LTE cell, or vice versa. A handover or cell reselection may also be performed when there is a coverage hole or lack of coverage in the TD-SCDMA network or when there is traffic balancing between the TD-SCDMA and LTE networks. As part of that handover or cell reselection process, while in a connected mode with a first system (e.g., TD-SCDMA) a UE may be specified to perform a measurement of a neighboring cell (such as LTE cell). For example, the UE may measure the neighbor cells of a second network for signal strength, frequency channel, and base station ID. The UE may then connect to the strongest cell of the second network. Such measurement may be referred to as inter-radio access technology (IRAT) measurement.

The UE may send a serving cell a measurement report indicating results of the IRAT measurement performed by the UE. The serving cell may then trigger a handover of the UE to a new cell in the other RAT based on the measurement report. The triggering may be based on a comparison between measurements of the different RATs. The measurement may include a TD-SCDMA serving cell signal strength, such as a received signal code power (RSCP) for a pilot channel (e.g., primary common control physical channel (P-CCPCH)). The signal strength is compared to a serving system threshold. The serving system threshold can be indicated to the UE through dedicated radio resource control (RRC) signaling from the network. The measurement may also include a neighbor cell received signal strength indicator (RSSI). The neighbor cell signal strength can be compared with a neighbor system threshold.

Other radio access technologies, such as a wireless local area network (WLAN) or WiFi may also be accessed by a user equipment (UE) in addition to cellular networks such as TD-SCDMA or GSM. For the UE to determine nearby WiFi access points (APs), the UE scans available WiFi channels to identify/detect if any WiFi networks exist in the vicinity of the UE. In one configuration, the UE may use TD-SCDMA reception/transmission gaps to switch to the WiFi network to scan the WiFi channels.

### Cell Reselection Via Active and Dormant Search Lists

Inter-radio access technology (IRAT) reselection from a first network, such as an LTE network, to a second network, such as a TD-SCDMA network, may be used when a UE is in an idle or discontinuous reception (DRX) mode of operation. In some cases, a multi-frequency network, such as TD-SCDMA, may be one of the networks specified for the IRAT reselection. Of course other networks are contemplated.

In a typical system, based on the current standard implementation, UEs are specified to support a minimum of eight frequency layers for reselections. The eight frequency layers may include a serving RAT frequency, serving RAT inter-frequencies, and/or target RAT frequencies. For some networks, such as LTE or TD-SCDMA, each layer refers to one frequency for the sake of this discussion. Alternatively, for other networks, such as GSM, each layer refers to a group of frequencies.

The frequency layers are broadcast from a source RAT. In one example, for an LTE to TD-SCDMA cell reselection, the target RAT frequency layers are broadcast from the source LTE cell and a list of TD-SCDMA frequency layers are also broadcast from the source LTE cell.

In the present application, frequency layers may be referred to as layers. Moreover, the terms layers and frequencies are used interchangeably with respect to the TD-SCDMA/LTE example discussed below because each layer corresponds to a single frequency. It is to be understood, however, that when other RATs (such as GSM) that include multiple frequencies in a single layer are considered, the term frequency (in the following description) may be intended to describe a layer and vice versa.

In a typical deployment, that supports both a first network, such as LTE, and a second network, such as TD-SCDMA, it is likely that the first network (e.g., source network) broadcasts more than eight layers as a possible set of reselection targets. Still, in some cases, due to memory constraints of the UE, the UE may prune layers from the list of target layers transmitted by the first network.

That is, in a typical system, the UE may truncate the layers when the network broadcasts a list of layers including target reselection frequencies, such as the source RAT inter-frequencies and/or target RAT frequencies. Specifically, the UE may truncate layers when the list of transmitted layers is greater than the minimum standard specifications and greater than UE's memory capacity. For example, if the minimum standard specification is eight layers, the UE may truncate the layers to eight layers or a number N that is greater than eight and less than or equal to the UE memory capacity.

In some cases, the network may be broadcasting on a frequency that has been pruned from the list. Therefore, the UE may be unaware of the broadcasted frequency as a result of the pruned layer. That is, the UE may only perform the reselection to the frequencies that remain on the truncated list. Thus, because the UE is limited to performing the reselection to the layers that remain on the truncated list, it is desirable to reduce the number of layers that are truncated by a UE.

According to an aspect of the present disclosure, a UE will not truncate layers when the number of layers is greater than the minimum standard specification. Rather, in one configuration, at any given time, a UE will actively search or measure frequencies of a number of layers up to the minimum standard specification, such as eight or N (where N is greater than the minimum standard specification and is based on the UE memory capacity). In the present configuration, the UE is configured to maintain three or more search lists. The search lists may include an active search list, a dormant search list, and a measurement list.

In one configuration, the active search list is specified to include layers that will be used by the UE to perform an active search. The search periodicity may be based on a total number of active layers in the measurement list and the active search list. Alternatively, the search periodicity may be pre-determined and/or user defined. When a frequency of a layer in the active search list is found as a result of the search operations, the UE may move the layer to a measurement list for continued periodic measurements to prepare for reselection evaluation. Furthermore, when a layer in the active search is not found as a result of the search operations, after a pre-determined number of search attempts, the UE may move the un-detected frequency to a dormant search frequency list. In one configuration, moving the un-detected frequency to the dormant search frequency list will trigger one or more frequencies from the dormant search-list to be moved to the active-search list.

In the present configuration, a dormant search list may be specified to include layers that will not be used for an active search operation performed by the UE. As previously discussed, a candidate layer may be moved from the dormant search list to the active search list when a candidate in the active search list is not detected with a search/detection operation. The movement of candidate layers from the dormant search list to the active search list may be performed based on a first-in, first-out (FIFO) basis. Still, the movement of candidate layers from the dormant search list to the active search list is not limited to a FIFO basis and the candidate layers may be moved based on other configurations.

Furthermore, in the present configuration, a measurement list may be specified for layers found from active search list. Specifically, the UE will periodically perform measurements of frequencies of the layers in the measurement list for re-selection purposes. Additionally, if the UE is unable to detect or obtain measurements of the specified frequencies after a specified number of attempts, the UE will move the candidate layer to the dormant search list. In one configuration, the periodicity for performing measurements of frequencies in the measurement list is different than the periodicity for searching for frequencies in the active search list. Moreover, the periodicity for performing measurements of frequencies in the measurement list may be more regular (e.g., shorter intervals) in comparison to the periodicity for searching for frequencies in the active search list.

TABLE I illustrates an example of a measurement list, an active search list, and a dormant search list according to an aspect of the present disclosure.

TABLE I

| Measurement List | Active Search List | Dormant Search List |
|---|---|---|
| LTE Layers: | TD-SCDMA Layer: | TD-SCDMA Layers: |
| LTE-F0, LTE-F1, | TDS-F3 | TDS-F4, TDS-F5, |
| LTE-F2, LTE-F3, | | TDS-F6, TDS-F7, |
| LTE-F4 | | TDS-F8, TDS-F9 |
| TD-SCDMA Layers: | | |
| TDS-F1, TDS-F2 | | |

As an example, as shown in TABLE I, the LTE serving layer is LTE-F0. Layers LTE-F1, LTE-F2, LTE-F3, LTE-F4 are inter-frequencies, and layers TDS-F1, TDS-F2, TDS-F3, TDS-F4, TDS-F5, TDS-F6, TDS-F7, TDS-F8, TDS-F9 are TD-SCDMA IRAT frequencies. Accordingly, the measurement list and the active search list include a total of eight layers and the dormant list includes six additional layers.

As shown in TABLE I, the UE may search for the TD-SCDMA frequency for the layer TDS-F3 because the layer TDS-F3 is in the active search list. In the present example, the layer TDS-F3 may be moved to the dormant search list if the search does not detect a frequency corresponding to the layer TDS-F3. In one configuration, a pre-determined number of searches are performed prior to moving the layer when a layer is not detected. Furthermore, one of the layers in the dormant search list may be moved to the active search list as a result of the layer TDS-F3 being moved to the dormant search list.

Alternatively, in the present example, the layer TDS-F3 may be moved to the measurement list if the search detects the layer TDS-F3. When the layer TDS-F3 is in the measurement list, the UE may periodically measure the layer TDS-F3 for re-selection. As previously discussed, the periodicity of measuring frequencies in the measurement list may be different from the periodicity for searching for frequencies in the active search list. For example, the frequencies of the layers in the measurement list may be measured with a periodicity of three seconds and the frequencies of the layers in the active search list may be searched with a periodicity of five seconds. As discussed above, the dormant search list and the measurement list may be dynamically updated based on the results of the search.

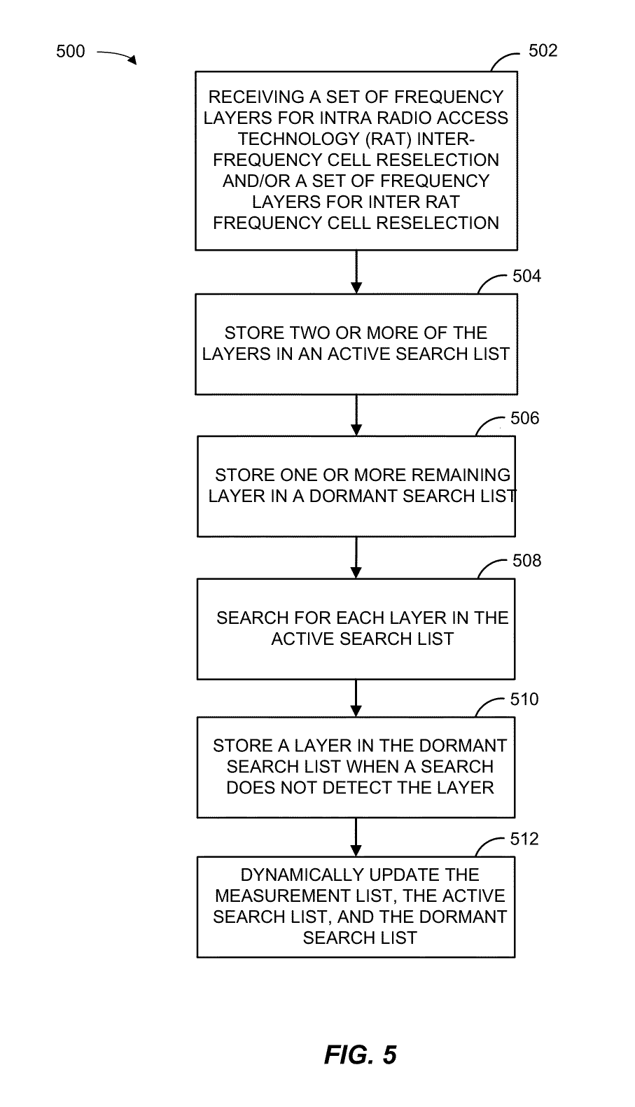

FIG. 5 shows a wireless communication method 500 according to one aspect of the disclosure. A UE receives a set of frequency layers for intra radio access technology (RAT) inter-frequency cell reselection and/or a set of frequency layers for inter RAT frequency cell reselection, as shown in block 502. The UE also stores some of the layers in an active search list, as shown in block 504. Furthermore, the UE stores remaining layers in a dormant search list, as shown in block 506. As shown in block 508, the UE searches for each layer in the active search list. Additionally, the UE stores a layer in the dormant search list when a search does not detect the frequency layer, as shown in block 510. Furthermore, as shown in block 512, the UE stores a frequency layer in a measurement list when the search detects the frequency layer. Finally, the UE dynamically updates the measurement list, the active search list, and the dormant search list, as shown in block 514.

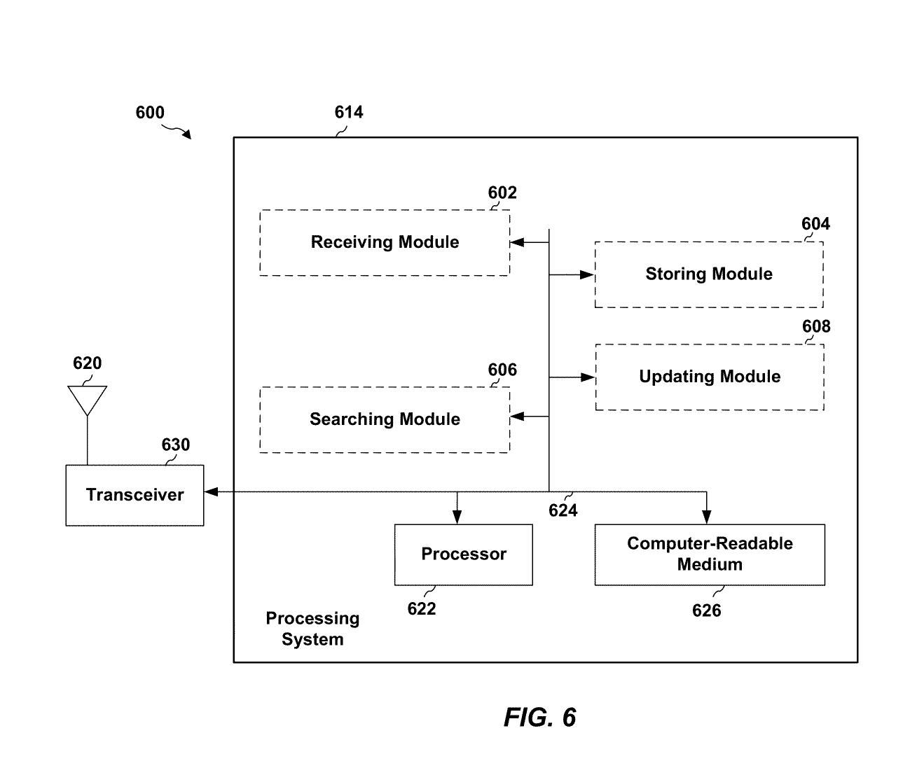

FIG. 6 is a diagram illustrating an example of a hardware implementation for an apparatus 600 employing a processing system 614. The processing system 614 may be implemented with a bus architecture, represented generally by the bus 624. The bus 624 may include any number of interconnecting buses and bridges depending on the specific application of the processing system 614 and the overall design constraints. The bus 624 links together various circuits including one or more processors and/or hardware modules, represented by the processor 622 the modules 602, 604, 606, 608 and the computer-readable medium 626. The bus 624 may also link various other circuits such as timing sources, peripherals, voltage regulators, and power management circuits, which are well known in the art, and therefore, will not be described any further.

The apparatus includes a processing system 614 coupled to a transceiver 630. The transceiver 630 is coupled to one or more antennas 620. The transceiver 630 enables communicating with various other apparatus over a transmission medium. The processing system 614 includes a processor 622 coupled to a computer-readable medium 626. The processor 622 is responsible for general processing, including the execution of software stored on the computer-readable medium 626. The software, when executed by the processor 622, causes the processing system 614 to perform the various functions described for any particular apparatus. The computer-readable medium 626 may also be used for storing data that is manipulated by the processor 622 when executing software.

The processing system 614 includes a receiving module 602 for receiving a set of frequency layers for intra radio access technology (RAT) inter-frequency cell reselection and/or a set of frequency layers for inter RAT frequency cell reselection. The processing system 614 includes a storing module 604 for storing some of the frequencies in an active search list. The storing module 604 may also be configured to store remaining frequency layers a dormant search list. Furthermore, the storing module 604 may be configured to store a frequency layer in the dormant search list when a search does not detect the frequency layer. Additionally, the storing module 604 may also be configured to store a frequency layer in a measurement list when the search detects the frequency layer. The storing module 604 may be one component or separate components for each search list. The processing system 614 also includes a searching module 606 for searching for each frequency layer in the active search list. Finally, the processing system 614 also includes an updating module 608 for dynamically updating the measurement list, the active search list, and the dormant search list.

The modules may be software modules running in the processor 622, resident/stored in the computer-readable medium 626, one or more hardware modules coupled to the processor 622, or some combination thereof. The processing system 614 may be a component of the UE 350 and may include the memory 392, and/or the controller/processor 390.

In one configuration, an apparatus such as a UE is configured for wireless communication including means for receiving. In one aspect, the receiving means may be the antennas 352, 620 the receiver 354, the channel processor 394, the receive frame processor 360, the receive processor 370, the controller/processor 390, 622, the memory 392, the search list module 391, the receiving module 602, and/or the processing system 614 configured to perform the functions recited by the aforementioned means.

Furthermore, in one configuration, an apparatus such as a UE is configured for wireless communication including means for storing. In one aspect, the storing means may be the controller/processor 390, 622, the memory 392, the search list module 391, the storing module 604 and/or the processing system 614 configured to perform the functions recited by the aforementioned means.

Additionally, in another configuration, an apparatus such as a UE is configured for wireless communication including means for searching. In one aspect, the searching means may be the antennas 352, 620, receiver 354, the receive frame processor 360, the receive processor 370, the controller/processor 390, 622, the memory 392, the search list module 391, the searching module 606, and/or the processing system 614 configured to perform the functions recited by the aforementioned means.

Additionally, in still yet another configuration, an apparatus such as a UE is configured for wireless communication including means for updating. In one aspect, the above means may be the controller/processor 390, 622, the memory 392, the search list module 391, the updating module 608 and/or the processing system 614 configured to perform the functions recited by the aforementioned means.

In another configuration, the aforementioned means, such as the updating means, searching means, storing means, and/or receiving means may be any module or any apparatus configured to perform the functions recited by the aforementioned means.

Several aspects of a telecommunications system has been presented with reference to LTE and TD-SCDMA systems. As those skilled in the art will readily appreciate, various aspects described throughout this disclosure may be extended to other telecommunication systems, network architectures and communication standards. By way of example, various aspects may be extended to other UMTS systems such as W-CDMA, high speed downlink packet access (HSDPA), high speed uplink packet access (HSUPA), high speed packet access plus (HSPA+) and TD-CDMA. Various aspects may also be extended to systems employing long term evolution (LTE)-advanced (LTE-A) (in FDD, TDD, or both modes), CDMA2000, evolution-data optimized (EV-DO), ultra mobile broadband (UMB), IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

Several processors have been described in connection with various apparatuses and methods. These processors may be implemented using electronic hardware, computer software, or any combination thereof. Whether such processors are implemented as hardware or software will depend upon the particular application and overall design constraints imposed on the system. By way of example, a processor, any portion of a processor, or any combination of processors presented in this disclosure may be implemented with a microprocessor, microcontroller, digital signal processor (DSP), a field-programmable gate array (FPGA), a programmable logic device (PLD), a state machine, gated logic, discrete hardware circuits, and other suitable processing components configured to perform the various functions described throughout this disclosure. The functionality of a processor, any portion of a processor, or any combination of processors presented in this disclosure may be implemented with software being executed by a microprocessor, microcontroller, DSP, or other suitable platform.

Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium. A computer-readable medium may include, by way of example, memory such as a magnetic storage device (e.g., hard disk, floppy disk, magnetic strip), an optical disk (e.g., compact disc (CD), digital versatile disc (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, or a removable disk. Although memory is shown separate from the processors in the various aspects presented throughout this disclosure, the memory may be internal to the processors (e.g., cache or register).

Computer-readable media may be embodied in a computer-program product. By way of example, a computer-program product may include a computer-readable medium in packaging materials. Those skilled in the art will recognize how best to implement the described functionality presented throughout this disclosure depending on the particular application and the overall design constraints imposed on the overall system.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A method of wireless communication, comprising:
receiving a set of frequency layers for intra radio access technology (RAT) inter-frequency cell reselection and/or a set of frequency layers for inter RAT frequency cell reselection;
storing a plurality of the frequency layers in an active search list;
storing at least one remaining frequency layer in a dormant search list;
searching for each frequency layer in the active search list;
storing a first selected frequency layer in the dormant search list when a search does not detect the first selected frequency layer;
storing the first selected frequency layer in a measurement list when the search detects the first selected frequency layer; and
dynamically updating the measurement list, the active search list, and the dormant search list.

2. The method of claim 1, in which dynamically updating comprises moving the first selected frequency layer from the measurement list to the dormant search list when a further search does not detect the first selected frequency layer.

3. The method of claim 2, in which dynamically updating further comprises moving a second selected frequency layer from the dormant list to the active search list when the first selected frequency layer is moved from the measurement list to the dormant search list.

4. The method of claim 1, in which the first selected frequency layer is moved to the dormant search list when the search is unsuccessful after multiple attempts on the active search list.

5. The method of claim 1, further comprising periodically measuring frequency layers in the measurement list.

6. An apparatus for wireless communications, comprising:
a memory; and
at least one processor coupled to the memory, the at least one processor being configured:
to receive a set of frequency layers for intra radio access technology (RAT) inter-frequency cell reselection and/or a set of frequency layers for inter RAT frequency cell reselection;
to store a plurality of the frequency layers in an active search list;
to store at least one remaining frequency layer in a dormant search list;
to search for each frequency layer in the active search list;
to store a first selected frequency layer in the dormant search list when a search does not detect the first selected frequency layer;
to store the first selected frequency layer in a measurement list when the search detects the first selected frequency layer; and
to dynamically update the measurement list, the active search list, and the dormant search list.

7. The apparatus of claim 6, in which the at least one processor is further configured to move the first selected frequency layer from the measurement list to the dormant search list when a further search does not detect the first selected frequency layer.

8. The apparatus of claim 7, in which the at least one processor is further configured to move a second selected frequency layer from the dormant list to the active search list when the first selected frequency layer is moved from the measurement list to the dormant search list.

9. The apparatus of claim 6, in which the first selected frequency layer is moved to the dormant search list when the search is unsuccessful after multiple attempts on the active search list.

10. The apparatus of claim 6, in which the at least one processor is further configured to periodically measure frequency layers in the measurement list.

11. An apparatus for wireless communications, comprising:
means for receiving a set of frequency layers for intra radio access technology (RAT) inter-frequency cell reselection and/or a set of frequency layers for inter RAT frequency cell reselection;
means for storing a plurality of the frequency layers in an active search list;
means for storing at least one remaining frequency layer in a dormant search list;
means for searching for each frequency layer in the active search list;
means for storing a first selected frequency layer in the dormant search list when a search does not detect the first selected frequency layer;
means for storing the first selected frequency layer in a measurement list when the search detects the first selected frequency layer; and
means for dynamically updating the measurement list, the active search list, and the dormant search list.

12. The apparatus of claim 11, in which the means for dynamically updating comprises means for moving the first selected frequency layer from the measurement list to the dormant search list when a further search does not detect the first selected frequency layer.

13. The apparatus of claim 12, in which the means for dynamically updating further comprises means for moving a second selected frequency layer from the dormant list to the active search list when the first selected frequency layer is moved from the measurement list to the dormant search list.

14. The apparatus of claim 11, in which the first selected frequency layer is moved to the dormant search list when the search is unsuccessful after multiple attempts on the active search list.

15. The apparatus of claim 11, further comprising means for periodically measuring frequency layers in the measurement list.

16. A computer program product for wireless communications, the computer program product comprising:
a non-transitory computer-readable medium having program code recorded thereon, the program code comprising:
program code to receive a set of frequency layers for intra radio access technology (RAT) inter-frequency cell reselection and/or a set of frequency layers for inter RAT frequency cell reselection;
program code to store a plurality of the frequency layers in an active search list;
program code to store at least one remaining frequency layer in a dormant search list;
program code to search for each frequency layer in the active search list;
program code to store a first selected frequency layer in the dormant search list when a search does not detect the first selected frequency layer;
program code to store the first selected frequency layer in a measurement list when the search detects the first selected frequency layer; and
program code to dynamically update the measurement list, the active search list, and the dormant search list.

17. The computer program product of claim 16, in which the program code further comprises program code to move the first selected frequency layer from the measurement list to the dormant search list when a further search does not detect the first selected frequency layer.

18. The computer program product of claim 17, in which the program code further comprises program code to move a second selected frequency layer from the dormant list to the active search list when the first selected frequency layer is moved from the measurement list to the dormant search list.

19. The computer program product of claim 16, in which the first selected frequency layer is moved to the dormant search list when the search is unsuccessful after multiple attempts on the active search list.

20. The computer program product of claim 16, in which the program code further comprises program code to periodically measure frequency layers in the measurement list.
